(19) United States
(12) Patent Application Publication
(10) Pub. No.: US 2025/0199288 A1
(43) Pub. Date: Jun. 19, 2025

(54) Method for ascertaining offset values of an immersion objective of an image-creating optical system, and arrangement and computer program

(71) Applicant: Carl Zeiss Microscopy GmbH, Jena (DE)

(72) Inventors: Thomas OHRT, Golmsdorf (DE); Christian DIETRICH, Jena (DE)

(73) Assignee: Carl Zeiss Microscopy GmbH, Jena (DE)

(21) Appl. No.: 18/979,828

(22) Filed: Dec. 13, 2024

(30) Foreign Application Priority Data
Dec. 15, 2023 (DE) 10 2023 135 360.8

(51) Int. Cl. G02B 21/36

(52) U.S. Cl. CPC G02B 21/365

(57) ABSTRACT

A method for ascertaining offset values for correcting the offset of an immersion objective of an image-creating optical system comprises the following steps: imaging an object using a reference objective of the optical system and the immersion objective without immersion and ascertaining offset values for an offset between the reference objective and the immersion objective with immersion on the basis of the image representations of the object

### CROSS-REFERENCE TO RELATED APPLICATION

This application claims the benefit of German Patent Application DE 10 2023 135 360.8, filed on Dec. 15, 2023, the content of which is incorporated by reference in its entirety.

### TECHNICAL FIELD

The disclosure relates to a method for ascertaining offset values of an immersion objective of an image-creating optical system, an arrangement having an image-creating optical system, and a computer program.

### BACKGROUND

In order to obtain microscopic recordings of an object to be imaged, for example a sample or preparation, with high magnification, it is conventional practice for the user to initially use a low-magnification objective in order to use the greater depth of field and larger image field to find and position the sample as efficiently as possible and without collisions. This is followed by a change to an objective with greater magnification. Significant deviations in the focal position can arise when changing objectives, inter alia on account of different tolerances of the microscope component parts, especially the objectives. This may render relatively significant refocusing necessary and may lead to an inefficient workflow. Even an automated autofocus harbours the risk of the sample focus being lost and the workflow being disturbed.

In this context, remedial action can be taken by way of installing washers of different thicknesses that are used to suitably correct the objective position. However, this manual correction is time consuming and can only be performed by specialists at the location of the optical system.

It is for this reason that a parfocal position correction, also referred to as parfocality correction below, can be carried out in the case of Z-motorized microscopes. In this respect, known values for the difference in focal positions when swivelling in a specific objective can be used to correct the position of the latter with the respect to the sample, for example by means of the microscope stand, such that the focal position is maintained. A corresponding method is described in DE 10 2008 063 799 A1.

In this context, the term parfocality denotes the property of an image-creating optical system, once set to focus on a location of the object to be imaged, to continue to image the said location in focus even in the event of a change in the system, e.g. a change of objective. For example, all objectives of a perfectly parfocal light microscope sharply image precisely the same plane of the object to be imaged, without requiring re-correction of the focus in the event of a change of objective. However, real microscope systems require a parfocal position correction or parfocality correction in order to regain the optimal focus on the target structure, which might have been lost due to material tolerances for example, when changing optical components such as e.g. an objective.

As a rule, for this the user needs to refocus, i.e. perform adaptations with respect to the position of the sample or imaging components, in order to sharply image a target structure in the image plane again. Such focal offsets can be an inherent property of an optical system. In the case of high-resolution microscope systems, the depths of field are of the order of a few micrometres, and manufacturing tolerances are already sufficient in that case to prevent further exact targeting of focal positions following a component change.

Such offsets can be corrected automatically in motorized optical systems. However, knowledge of the required parfocality offset values that can be used to correct parfocality is indispensable in that case.

However, the previous workflow for ascertaining the required parfocality offset values is very complicated, and parts thereof have to be performed manually. In this context, immersion objectives in particular lead to drastic increase in the time outlay or duration of the calibration time since immersion liquids need be applied to and subsequently also completely removed from the sample. Moreover, application of immersion liquid is usually linked to sample removal, and this again leads to inaccuracies during the workflow for determining the Z-correction for the parfocality to be applied.

Moreover, consideration must be given to the sequence of objectives since the procedure is carried out from the objective with the highest resolution to the objective with the lowest resolution. Since this workflow should be performed manually by the user, it is often afflicted by errors. Additionally, the user always needs to recalibrate all objectives since the prior art provides no solution for performing the correction for only a single objective. Ultimately, this means that the state-of-the-art parfocality correction should only be performed by experienced users who are well acquainted with the microscope. This leads to significant limitations in relation to user friendliness and efficiency of the microscopy process.

In summary, previous parfocality correction methods are usually not automatable, or at least not fully automatable, and instead require manual implementation on the stand and only in conjunction with the respective eyepieces. There is significant susceptibility to errors, inter alia on account of the numerous method steps. Inexperienced users, in particular, find implementation of the parfocality correction difficult. Moreover, the known methods are very time consuming since the full workflow always requires renewed calibration of all objectives. Furthermore, correcting the parfocality of immersion objectives is very time intensive on account of the use of immersion liquids.

In addition to parfocality deviations, parcentricity deviations might also occur during a change of objective. Hence, a parcentricity correction, in addition to a parfocality correction, might also be advantageous following a change of objective. In this context, the term parcentricity denotes the property of an image-creating system of keeping the centre of the image in the image centre, and not laterally displacing the said centre, in the event of a change in the system, e.g. a change of objective. A parcentricity-type position correction or parcentricity correction consequently enables the best possible parcentricity.

### SUMMARY

The present application specifies a method and an arrangement that allow the aforementioned disadvantages to be avoided at least in part. A simplified ascertainment of offset values, on the one hand requiring little outlay in terms of time and effort and on the other hand being very accurate even in the hands of less trained users where possible, which preferably can be performed in at least partly automated fashion, is desirable.

This is achieved by the subject matter of the independent claims. The dependent claims relate to embodiment variants of these solutions according to the invention.

A basic idea of the present disclosure is that an immersion objective induces optical imaging even without immersion, and this can be used to ascertain offset values. For example, the optical image representation generated without immersion can allow experimental determination of a focal position of a swivelled-in immersion objective relative to a sample or target structure. Even if the attained resolution is reduced and aberrations arise, it is possible to ascertain a focal position with an accuracy of a few micrometres.

This can be implemented in automated fashion by evaluating images from a z-stack on the basis of their contrast and/or resolution. In other words, the contrast and/or the resolution of a plurality of images recorded with different distances between the objective and sample in the z-direction, i.e. in the direction of the optical axis, can be analysed and used for a subsequent definition of correction values for a parfocality correction.

User samples can be used in a simple case here. In an alternative to that or in addition, use can be made of at least one reference sample, the structure of which is known and optionally optimized in conjunction with the evaluation of image stacks in respect of robustness and accuracy. However, if present, a hardware autofocus system that e.g. is reflection based, uses time-of-flight measurements and/or is triangulation based, or an image-based computer-implemented autofocus method can also be used to ascertain the position of sample faces vis-à-vis the objective for as long as the detection principle supplies a reliable position value both with and without an immersion.

The described basic concept allows ascertainment of offset values for immersion objectives even without the introduction of an immersion liquid, in particular ascertainment of parfocality offset values that allow parfocal position correction vis-à-vis further objectives assembled in the objective turret. In an alternative to that or in addition, a parcentricity-type position correction can also be rendered possible by virtue of ascertaining appropriate parcentricity offset values.

The offset effect in the axial direction, i.e. in the z-direction, which arises on account of the optical effect of the “missing” immersion can be determined both theoretically and experimentally. This allows ascertainment of the parfocal correction value to be used when immersion has been introduced, in order to correct the axial position for the focal position in the sample following a change between objectives. For the parcentricity-type correction, it can be assumed to a good approximation that the immersion liquid, as an isotropic medium, does not bring about an offset, i.e. a shift, in the lateral direction.

A first aspect of the disclosure relates to a method for ascertaining offset values for correcting the offset of an immersion objective of an image-creating optical system.

The method can be carried out in computer-implemented fashion, e.g. using data processing systems; i.e. at least one method step, preferably a plurality of method steps or all method steps can be carried out using a computer program. There is the option of the method being performed in fully automated fashion, i.e. without user interaction.

The image-creating optical system can be a light microscope which provides, e.g. on an objective turret, different objectives with different magnifications or contrast options. For example, the light microscope can be designed as an upright microscope or as an inverted microscope. The image-creating optical system comprises at least two objectives, at least one objective of which is designed as an immersion objective, i.e. for use with an immersion liquid. It is also possible that all objectives are designed as immersion objectives. For example, water, glycerine, oil mixtures, oils or silicone oils can be used as immersion liquids, with the invention not being restricted to any specific immersion liquid.

The proposed method provides for an object to be initially imaged by a reference objective of the optical system and by the immersion objective, in each case without immersion.

Subsequently, offset values are ascertained for an offset between the reference objective and an immersion objective, the said values representing the offset with immersion, using the image representations of the object without immersion or on the basis of the image representations of the object without immersion. In other words, both the reference objective and the immersion objective without immersion are used for ascertaining the offset values; however, offset values are ascertained for the offset with immersion.

Optionally, base offset values representing the offset without immersion can be ascertained for an offset between the reference objective and an immersion objective in an intermediate step, and the said base offset values can subsequently be used as a basis for ascertaining the offset values. This means that the offset values can be ascertained on the basis of the said base offset values or by way of a direct or indirect inclusion of the base offset values.

In a simple case, an ascertained base offset value can in this case be equated to the actual offset value. An offset correction with an accuracy sufficient for many applications can thus be made possible in a very simple manner.

Alternatively, the base offset value can be converted into the offset value by means of one or more corrections, e.g. by applying one or more correction values, in particular a correction value for the immersion. A more accurate offset correction can be made possible by correcting for the lack of immersion during the imaging of the object.

The offset values can subsequently be used to perform an offset correction, e.g. compensating for a parfocality offset. Moreover, the base offset values and/or the offset values can be stored for subsequent use.

The reference objective can be a dry objective or likewise an immersion objective. Should the image-creating optical system comprise more than two objectives, a specific objective can be used as reference objective for ascertaining the offset values for the offset correction of a plurality of further objectives.

Alternatively, the property of an objective being a reference objective can change, i.e. a first reference objective is used to ascertain offset values for a second objective. Following this ascertainment procedure, the second objective serves as new reference objective serving to ascertain and optionally correct the offset values for a third objective, etc.

A combination of the two procedures is also possible, i.e. it is e.g. possible to initially use a specific reference objective to ascertain offset values for a plurality of further objectives, with one of these further objectives subsequently being used as new reference objective. The determination of an objective as reference objective is a free determination which defines the objective that is used as mathematical reference. It is advantageous for base offset values or quantities underlying these, e.g. focal positions of a target structure, to be ascertained without immersion in one measurement process for all objectives. Base offset values, e.g. parfocality base offset values, between two objectives can be determined directly from the two measurement results without immersion assigned to the objectives, e.g. the ascertained focal positions.

If an objective is subsequently used or replaced, it is sufficient to subject the new objective and a reference objective, to be defined, to the proposed measurement process, i.e. the measured quantities that underlie the base offset value of the new objective without immersion, e.g. the focal position, are ascertained, and the base offset value is ascertained therefrom. The new objective can be referenced to the other objectives by measuring the reference objective.

In accordance with the proposed method, the offset values for all objectives are ascertained without immersion. In this context, an essential insight of the inventors is that even without immersion the offset of an immersion objective can be determined sufficiently exactly to perform the offset correction, this despite the said immersion objective being designed for use with an immersion liquid.

The proposed method advantageously allows an offset correction for an image-creating optical system, in particular for a light microscope, having a plurality of objectives, the said offset correction being performable with an identical procedure independently of the immersion objective allocation. The method can also be used for OEM systems since the use of product-specific software is not mandatory. Therefore, the method is universally usable.

The proposed method offers the possibility of a software-controlled and automatable solution for motor-driven offset correction even in the case of immersion objectives, without an auto immersion needing to be performed or, in general, an immersion fluid needing to be applied. The method no longer only enables a calibration to be defined manually but a workflow which can be executed without manual interventions by a user. In other words, the method can also be performed by less trained users, or even in automated fashion, without this impairing the accuracy.

For example, this also relates to sample or reference carriers which are no longer contaminated by immersion media during the calibration of immersion objectives. It is possible to manage without cleaning, and reliable reusability is ensured. Since use of the immersion liquid is dispensed with, the method is moreover linked to significant savings of time in comparison with previous methods of offset correction. Moreover, the user acceptance can be increased, i.e. the user is more likely prepared to implement the necessary offset correction, and this may subsequently lead to more correct imaging results.

For as long as the reference objective remains a constituent part of the optical system, i.e. remains installed in the latter, it may be sufficient in the event of one or more changes of objectives elsewhere, for example in the event of changing a 3rd, 4th or 5th objective in addition to the aforementioned reference objective and immersion objective, to ascertain the offset value only for the newly introduced objective or objectives, and to make continued use of the other values.

In the process, it can be advantageous for the offsets caused by the lack of immersion to be compensated for by means of the previously ascertained offset values, as a result of which only the remaining deviations, e.g. due to manufacturing tolerances, need to be measured and corrected. When correcting parfocality, the focal position can be obtained faster as a result, and so the method can be carried out faster overall. Moreover, the offset values can be ascertained more robustly and with greater accuracy since there has already been a basic correction.

According to various embodiment variants, offset values can be ascertained for correcting parfocality and/or correcting parcentricity.

Parfocality correction in particular, but also parcentricity correction, enables high-quality optical imaging and simplifies optional subsequent image processing and image analysis.

For example, the ascertainment of the offset values for correcting parfocality can comprise the steps mentioned below:

ascertaining a focal position of the reference objective of the image-creating optical system without immersion, ascertaining a focal position of the immersion objective without immersion and ascertaining a parfocality offset value for a parfocality offset between the immersion objective and the reference objective on the basis of the ascertained focal positions and at least one parfocality correction value. In this case, the focal positions can be ascertained on the basis of the image representations of the object generated without immersion by way of the reference objective or the immersion objective.

Optionally, the ascertained parfocality offset value can be stored for subsequent use.

Optionally, the method can comprise a compensation of the parfocality offset between the immersion objective and the reference objective by means of the ascertained parfocality offset value. The parfocality offset can be compensated for, especially in the event or context of a change between the reference objective and the immersion objective operated with immersion.

The aforementioned and subsequently optionally mentioned method steps can be carried out in the specified sequence; however, if need be, they can also be carried out in a different sequence or with partial or complete overlap in time. For example, it is also possible to initially ascertain the focal position of the immersion objective and subsequently ascertain the focal position of the reference objective.

In accordance with the proposed method, the focal positions for all objectives are ascertained without immersion. In this context, an essential insight of the inventors is that even without immersion the focal position can be determined sufficiently exactly with an immersion objective to perform the parfocality correction according to the proposed method, this despite the said immersion objective being designed for use with an immersion liquid.

The value for the actual focal position and hence the value of the parfocality offset (parfocality offset value) can be determined on the basis of the ascertained focal positions of the reference objective and immersion objective if a parfocality correction value is taken into account.

The parfocality correction value serves to correct the lack of immersion when determining the focal position of the immersion objective and optionally the lack of immersion when determining the focal position of the reference objective should the reference objective likewise be an immersion objective. In other words, the parfocality correction value can be considered an immersion correction value for correcting the parfocality offset. What follows therefrom is that parfocality correction values between objectives can be divided among the individual objectives, and the following applies: cᵢⱼ=c+cᵢ. It is clear from the definition that the contribution cᵢ for objectives without immersion is equal to zero.

The parfocality correction value or values can be determined once in advance and can be stored for subsequent use in the proposed method, or, in other words, the said value or values can be retrieved from a memory unit within the scope of the proposed method. Furthermore, it is possible to parameterize parfocality correction values, e.g. ascertained in a computing unit, with respect to dependencies on ambient parameters such as temperature, carrier substrate thickness, etc., and to derive derived parfocality correction values for specific ambient conditions, as will still be explained in detail below.

Ascertaining the parfocality offset value on the basis of the ascertained focal positions means that the ascertained focal positions are taken into account directly or indirectly when ascertaining the parfocality offset value. For example, the ascertained focal positions can be corrected by means of parfocality correction values for the individual objectives, and the corrected focal positions are subsequently used to ascertain the parfocality offset value between the objectives.

Alternatively, it is possible to initially ascertain a parfocality base offset value for the parfocality base offset between the immersion objective and the reference objective from the ascertained focal positions without immersion, and the said parfocality base offset is then corrected by means of the parfocality correction value. In this case, the parfocality offset value is ascertained on the basis of the parfocality base offset value and the parfocality correction value. It can be advantageous for the reference objective not to be an immersion objective in order to avoid errors when converting parfocality base offset values into parfocality offset values. Since the measurement error is relevant when determining the focus using the reference objective, it is moreover advantageous to use an objective with a small depth of field, i.e. with a high numerical aperture, as reference objective.

Ascertaining the parfocality base value offset is advantageous in that the relevant offset value between objectives due to tolerances is determined therewith and offset values of the individual focal positions can be adjusted therewith.

In a further, optional method step, the parfocality offset between the immersion objective and the reference objective can subsequently be compensated for by means of the ascertained parfocality offset value after immersion was applied to the immersion objective. This compensation can be implemented by suitable measures, for example displacing or shifting the focusing drive of the immersion objective, displacing an object stage/holding frame, e.g. microscope or object stage and/or z-piezo holding frame, in the z-direction, displacing the immersion objective relative to the object to be imaged, or displacing one or more correction lenses and/or a motor-driven correction ring of the objective.

The ascertained parfocality offset value can be stored for subsequent use, and so it can be used during a subsequent renewed use of this specific objective combination without a renewed ascertainment of the focal positions. In other words, the parfocality offset value ascertained once can be used directly for the compensation of the parfocality offset in the case of a renewed change of objective, i.e. in the case of the renewed use of a specific objective.

The proposed method advantageously allows a parfocality correction for an image-creating optical system, in particular for a light microscope, having a plurality of objectives, the said method being performable with an identical procedure independently of the immersion objective allocation. The method can also be used for OEM systems since the use of product-specific software is not mandatory. Therefore, the method is universally usable.

The proposed method offers the possibility of a software-controlled and automatable solution for ascertaining the motor-driven parfocality correction even in the case of immersion objectives, without an auto immersion needing to be performed or, in general, an immersion fluid needing to be applied. The method no longer only enables a calibration to be defined manually but a workflow which can be executed without manual interventions by a user. In other words, the method can also be performed by less trained users, or even in automated fashion, without this impairing the accuracy.

For example, this also relates to sample or reference carriers which are no longer contaminated by immersion media during the calibration of immersion objectives. It is possible to manage without cleaning, and reliable reusability is ensured. Since use of immersion liquid is dispensed with, the method is moreover linked to significant savings of time in comparison with previous methods of parfocality correction. Moreover, the user acceptance can be increased, i.e. the user is more likely prepared to implement the necessary offset correction, and this may subsequently lead to more correct imaging results. In particular, it is also possible to avoid collisions between objective and sample because the user comes across (pre-) adjusted Z-conditions. In fact, minor manual corrections are still required at best. Comprehensive corrections with travels far away from the focal positions, which might lead to the aforementioned collisions, are no longer required.

According to various embodiment variants, the method can comprise an ascertainment of offset values for a parcentricity correction or parcentricity-type position correction with the steps mentioned below: ascertaining an object position of an object by means of the reference objective without immersion, ascertaining the object position of the object by means of the immersion objective without immersion and ascertaining a parcentricity offset value for a parcentricity offset between the immersion objective and the reference objective on the basis of the ascertained object positions without immersion.

Should both a parcentricity correction and a parfocality correction be performed, it is possible to advantageously use the same object as the object for determining the object positions or for ascertaining the focal positions. This simplifies the procedure and has a time-saving effect since no large travels are required to find a further object. However, there is also the option of using different objects for the two corrections. This can enable a more accurate correction since objects can be optimized for the respective correction to be performed in the case of separate objects.

Optionally, the parcentricity offset value can be ascertained on the basis of the ascertained object positions without immersion and at least one parcentricity correction value. The parcentricity correction value can at least approximately compensate the lack of immersion and thereby contribute to a very accurate parcentricity correction.

For a lateral correction, i.e. the parcentricity correction, it is possible to assume to a very good approximation that differences in the lateral position, e.g. caused by the tilt of optical elements, between a determination with immersion and a determination without emersion will be very small, and can consequently be set to zero. The parcentricity correction can advantageously be simplified and, in particular, performed quicker by virtue of not using a parcentricity correction value or using a value of zero for the parcentricity correction value. The parcentricity offset value between objectives can consequently be ascertained directly from the ascertained offset of an object structure in the image.

It is advantageous to position a corresponding target structure of the object in the image centre by means of a sample stage, and thus ascertain the offset value, to be corrected, between the objectives directly by way of the sample stage travel required in the process. It is advantageous if the sample stage is motor driven to this end and controllable by way of a control unit. Alternatively, the parcentricity offset value can be determined on the basis of evaluating digital or image data which assess offset effects and/or scaling effects. A combination of both approaches is also possible.

Further optionally, the method can comprise a compensation of the parcentricity offset between the immersion objective and the reference objective by means of the ascertained parcentricity offset value. The parcentricity offset can be compensated for, especially in the event or context of a change between the reference objective and the immersion objective operated with immersion.

The explanations given above in relation to the ascertainment of the parfocality offset value apply accordingly to the ascertainment of the parcentricity offset value, with the exception of the deviations described below.

For parcentricity correction, the object positions of the object to be imaged are initially ascertained for the reference objective and the immersion objective, the offset of which with respect to the reference objective is intended to be corrected.

The object position of the object is ascertained without immersion for both objectives. In this context, ascertaining the object position means that the position of one or more features of the object is determined using the reference objective and the immersion objective, in order to be able to ascertain a lateral displacement of the image on the basis thereof. In this context, an essential insight of the inventors is that even without immersion the object position can be determined sufficiently exactly with an immersion objective to perform the parcentricity correction according to the proposed method, this despite the said immersion objective being designed for use with an immersion liquid.

The parcentricity offset value is determined on the basis of the ascertained object positions, with a parcentricity correction value optionally being taken into account, the said parcentricity offset value specifying the extent of the parcentricity offset between the immersion objective and the reference objective.

The parcentricity correction value serves to correct the lack of immersion when determining the object position using the immersion objective and optionally the lack of immersion when determining the object position using the reference objective should the reference objective likewise be an immersion objective. In other words, the parcentricity correction value can be considered an immersion correction value for correcting the parcentricity offset. Hence it is clear that parcentricity correction values between objectives can be divided among the individual objectives, and the following applies: dᵢⱼ=dᵢ+dⱼ. It is clear from the definition that the contribution dᵢ for objectives without immersion is equal to zero.

The parcentricity correction value or values can be determined once in advance and can be stored for subsequent use in the proposed method, or, in other words, the said value or values can be retrieved from a memory unit within the scope of the proposed method. Furthermore, it is possible to parameterize parcentricity correction values, e.g. ascertained in a computing unit, with respect to dependencies on ambient parameters such as temperature, carrier substrate thickness, etc., and to derive derived parcentricity correction values for specific ambient conditions, as will still be explained in detail below.

Ascertaining the parcentricity offset value on the basis of the ascertained object positions means that the ascertained object positions are taken into account directly or indirectly when ascertaining the parcentricity offset value. For example, the ascertained object positions can be corrected by means of parcentricity correction values, and the corrected object positions are subsequently used to ascertain the parcentricity offset value.

Alternatively, it is possible to initially ascertain a parcentricity base offset value for the parcentricity base offset between the immersion objective and the reference objective from the ascertained object positions without immersion, and the said parcentricity base offset value is then corrected by means of the parcentricity correction value. In this case, the parcentricity offset value is ascertained on the basis of the parcentricity base offset value and the parcentricity correction value.

In a further, optional method step, the parcentricity offset between the immersion objective and the reference objective can subsequently be compensated for by means of the ascertained parcentricity offset value. This compensation can be implemented by suitable measures such as e.g. a displacement or shift of the microscope stage in the x- and/or y-direction, in order to displace, relative to the immersion objective, the object to be imaged. In the case of digital image recordings, the parcentricity offset can also be compensated for digitally within the scope of processing and displaying the image data.

The ascertained parcentricity offset value can be stored for subsequent use, and so it can be used during a subsequent renewed use of a specific objective combination without a renewed ascertainment of the focal positions. In other words, the parcentricity offset value ascertained once can be used directly for the compensation of the parcentricity offset in the case of a renewed change of objective, i.e. in the case of the renewed use of a specific objective.

The parcentricity correction makes it easier to observe the object to be imaged since, following the parcentricity correction, the object point situated at the centre of the image field still is at the image centre with essentially an unchanged position even when objectives have been changed and even in the event of a change of magnification. Parcentricity and parfocality can be corrected together in order to correct an objective offset not only in the z-direction but also in the x- and y-directions and thus improve the imaging quality. The advantages described in respect of the parfocality correction are correspondingly connected to the parcentricity correction. In particular, it is possible to manage without immersion, and this is accompanied by significant time savings and a substantially reduced cleaning outlay.

Improved imaging quality as a result of a preceding parfocality correction can lead to a more accurate determination of the parcentricity offset. Thus it might be advantageous to correct parfocality first, and subsequently perform a parcentricity correction.

According to further embodiment variants, the method can include ascertaining the parfocality correction value and/or the parcentricity correction value by experiment, using the immersion objective with immersion.

This means that the focal position of the immersion objective and/or the object position of the object can be determined, for example once, using the immersion objective with immersion. On the basis thereof, it is possible to determine the deviation of the focal position and/or object position, or the deviation of the parfocality base offset value and/or parcentricity base offset value, between a use of the immersion objective with immersion and a use thereof without immersion, and the parfocality correction value or parcentricity correction value can be determined accordingly.

Ascertaining the parfocality correction value and/or parcentricity correction value by experiment is advantageous in that all actual properties, even possibly unknown influencing factors, of the image-creating optical system and of the immersion objective can be taken into account. Thus, a determination by experiment can supply a very accurate parfocality correction value and/or parcentricity correction value.

According to further embodiment variants, the method can include ascertaining the parfocality correction value and/or the parcentricity correction value by calculation by means of simulation and/or computation.

This means that the focal position of the immersion objective and/or the object position of the object to be imaged can be determined for example by means of simulation and/or computation. On the basis thereof, it is possible to determine the deviation of the focal position and/or object position, or the deviation of the parfocality base offset value and/or parcentricity base offset value, between a use of the immersion objective with immersion and a use thereof without immersion, and the parfocality correction value or parcentricity correction value can be determined accordingly.

Determining the parfocality correction value and/or parcentricity correction value by calculation is advantageous in that there is no need for a lengthy experimental determination that requires significant resources, depends on the individual case and moreover is connected to significant cleaning outlay and can only be carried out by trained staff. In contrast, an ascertainment by calculation can optionally even be implemented universally for a specific equipment or microscope type and/or optionally be implemented on the basis of software, for example within the scope of remote maintenance. Thus it might be possible to manage without user interaction. Moreover, the user acceptance for this with regards to even carrying out correction can be increased, as it is linked to little outlay. Even if the accuracy of a parfocality correction value or parcentricity correction value ascertained by calculation can be lower than that of an experimentally ascertained parfocality correction value or parcentricity correction value, it can in any case enable an offset correction which supplies better imaging in comparison with imaging without any offset correction.

Combining an experimental and computational ascertainment of the parfocality correction value and/or parcentricity correction value is also possible. The parfocality correction value or parcentricity correction value ascertained experimentally and/or by calculation can be stored, e.g. in a memory unit, such that the correction value can be retrieved from memory during later use and need not be determined again.

According to further embodiment variants, the method can include correcting the parfocality offset and/or parcentricity offset compensated by means of the computationally ascertained parfocality correction value and/or parcentricity correction value, ascertaining a corrected parfocality correction value and/or corrected parcentricity correction value on the basis of the compensated parfocality offset and/or parcentricity offset, and storing the corrected parfocality correction value and/or corrected parcentricity correction value.

For example, the original parfocality correction value and/or parcentricity correction value can be overwritten with the corrected parfocality correction value or the corrected parfocality correction value or the corrected parfocality correction value and/or corrected parcentricity correction value can be stored in addition to the original parfocality correction value or parcentricity correction value. To correct the offset, use can subsequently be made of the stored corrected parfocality correction value and/or corrected parcentricity correction value.

On the one hand, a very accurate parfocality correction value or parcentricity correction value can be ascertained by the described combination of ascertaining the parfocality correction value and/or parcentricity correction value by calculation, in combination with an experimental optimization, with the result that a very accurate offset correction can be implemented on the basis thereof. On the other hand, the method can be performed in time-saving fashion since the parfocality correction value or parcentricity correction value ascertained by calculation is already close to the optimized parfocality correction value or parcentricity correction value.

The corrected parfocality correction value or parcentricity correction value can also be stored for subsequent use.

According to further embodiment variants, the parfocality correction value and/or the parcentricity correction value can take account of an influencing factor selected from a group comprising a composition of an immersion liquid, a temperature of the immersion liquid, a wavelength of an electromagnetic radiation used for imaging with the image-creating optical system, a thickness of a carrier substrate, a refractive index of the carrier substrate, a distance of the object from the carrier substrate, a setting of a correction element of the immersion objective, e.g. a correction ring or a stop, and a position of the object with respect to the carrier substrate.

In other words, one of the aforementioned influencing factors or boundary conditions, or any desired combination of the aforementioned influencing factors, can be taken into account. Expressed differently, the parfocality correction value or parcentricity correction value can apply to a specific combination of influencing factors, e.g. to a specific composition of the immersion liquid, and can be determined accordingly. It is also possible to take account of mutual influencing of the influencing factors among themselves.

Axial offset values in particular can be influenced by various influencing factors, and these can additionally be taken into account in order to enable an even more accurate offset correction. For example, the temperature can influence the refractive index of the immersion liquid used.

The aforementioned influencing factors can be taken into account by virtue of being included in the ascertainment of the parfocality offset or parcentricity offset. In other words, the parfocality correction value or parcentricity correction value can also represent such influencing factors.

In general, the influence one or more of the aforementioned influencing factors have on parfocality correction values and/or the parcentricity correction values can also be ascertained, stored and applied at a later time to a specific parfocality correction value or parcentricity correction value to be ascertained. For example, a temperature correction factor can be determined in general and can then be taken into account when ascertaining a specific parfocality correction value and/or the parcentricity correction value.

According to further embodiment variants, the focal positions can be ascertained in automated fashion.

To this end, use can be made of a hardware autofocus system that e.g. is reflection based, uses time-of-flight measurements and/or is triangulation based, or an image-based computer-implemented autofocus method. Automated ascertainment of the focal positions advantageously enables an automation of the proposed method; this can be accompanied by a shortening of the method duration and can dispense with user interaction.

According to further embodiment variants, the object that is imaged can be an object arranged permanently on the optical system or arranged stationarily on a carrier substrate.

In particular, the object can comprise a target structure enabling a focal position ascertainment that is as accurate as possible. An object arranged permanently on the optical system is advantageous in that this, as a stationary object, represents a stable reference and can therefore be imaged under the same conditions at different times, and this allows a meaningful comparison to be made between the image representations. Consequently, when further objectives are changed, the image representations of the object or its target structure obtained previously can continue to be used. It is therefore possible to manage without renewed imaging of the object using the reference objective, and so the offset correction can be implemented quickly and without a complex procedure.

In addition to that or in an alternative, markings as an object or target structure can be securely attached to the carrier substrate and/or can be formed as an integrated constituent part of the carrier substrate. Advantageously, this can enable an accurate automated determination of the parfocality and parcentricity for different objective magnifications.

A further aspect of the disclosure relates to an arrangement having an image-creating optical system with an immersion objective and a reference objective, and means adapted such that they carry out the steps of one of the above-described methods.

Consequently, the explanations given above for the purpose of explaining the methods also serve to describe the proposed arrangement. The advantages of the method are correspondingly connected with the arrangement.

The means adapted such that they carry out the method steps can for example be designed as described below.

The means can comprise a device, e.g. in the form of a processing and control unit, configured and designed to ascertain offset values for the offset between the reference objective and the immersion objective on the basis of image representations of the object.

Optionally, the means can comprise a device for compensating a parfocality offset between the immersion objective and the reference objective, e.g. in the form of an object stage that is displaceable in the z-direction, optionally in motor-driven fashion, in the form of a correspondingly displaceable focusing drive and/or in the form of one or more displaceable zoom lenses in the zoom body of the immersion objective.

Moreover, the means might comprise a memory unit designed to store values, e.g. focal positions of the objectives without immersion, parfocality base offset values between the immersion objective and the reference objective without immersion, parfocality offset values between the immersion objective and the reference objective, object positions of the object, parcentricity base offset values between the immersion objective and the reference objective and/or parcentricity offset values.

Optionally, the memory unit can be designed to store corrected parfocality correction values and/or corrected parcentricity correction values.

For example, the processing and control unit can be configured and designed to ascertain a parfocality offset value between the immersion objective and the reference objective on the basis of the stored focal positions and/or the stored parfocality base offset value and also a parfocality correction value, and to generate and output a control signal which brings about compensation of a parfocality offset between the immersion objective and the reference objective by means of the ascertained parfocality offset value. The processing and control unit can be realized in hardware and/or software and can be physically designed in one or more parts.

Furthermore, the processing and control unit can be configured and designed to ascertain a parcentricity offset value between the immersion objective and the reference objective on the basis of the stored object positions and/or the stored parcentricity base offset value and also a parcentricity correction value, and to generate and output a control signal which brings about compensation of a parcentricity offset between the immersion objective and the reference objective by means of the ascertained parcentricity offset value.

Further optionally, the processing and control unit can be configured and designed to ascertain the parfocality correction value and/or the parcentricity correction value by calculation, and further optionally designed to ascertain a corrected parfocality correction value and/or corrected parcentricity correction value. To this end, the control unit can further optionally be configured and designed to take account of an influencing factor selected from a group comprising a composition of an immersion liquid, a temperature of the immersion liquid, a wavelength of an electromagnetic radiation used for imaging with the image-creating optical system, a thickness of a carrier substrate, a refractive index of the carrier substrate, a distance from the object to be imaged, a setting of a correction element of the immersion objective.

Moreover, the means can comprise a device for automated ascertainment of the focal positions of the immersion objective and/or of the reference objective, or the processing and control unit can be designed accordingly.

The image-creating optical system can be a light microscope according to various embodiment variants.

In light microscopes, an offset correction is particularly important in order to obtain image representations of sufficient quality.

A further aspect of the disclosure relates to a computer program comprising commands that cause the proposed arrangement to carry out one of the proposed methods.

Consequently, the explanations given above for the purpose of explaining the methods and the arrangement also serve to describe the proposed computer program. The advantages of the method and the arrangement are correspondingly connected with the computer program.

A computer program can be understood to mean program code that is storable on a suitable medium and/or retrievable from a suitable medium. Any medium suitable for storing software, for example a non-volatile memory installed in a controller, a DVD, a USB stick, a flash card or the like, can be used to store the program code. By way of example, the program code can be retrieved via the Internet or an intranet or via another suitable wireless or wired network.

The computer program can be stored on a non-transitory, computer-readable medium and/or be transmitted by means of the data carrier signal.

Further advantages of the present invention are evident from the drawings and the associated description, on the basis of which the invention will be explained in detail below.

### BRIEF DESCRIPTION OF THE DRAWINGS

FIG. 1 shows a schematic illustration of an exemplary arrangement;

FIG. 2 shows a flowchart of an exemplary method for correcting the offset of an immersion objective;

FIG. 3 shows a flowchart of a further exemplary method for correcting the offset of an immersion objective;

FIG. 4 shows an image representation serving to explain the parfocality base offset;

FIG. 5 shows an image representation serving to explain the parfocality offset;

FIG. 6 shows a block diagram of the exemplary arrangement of FIG. 1;

FIG. 7a shows an illustration of the imaging setup with the sample in direct contact with the immersion liquid;

FIG. 7b shows an illustration of the imaging setup with the sample behind a first substrate; and

FIG. 7c shows an illustration of the imaging setup with a sample positioned at a distance behind the carrier substrate.

### DETAILED DESCRIPTION

It is understood that other embodiments can be used and structural or logical modifications can be undertaken, without departing from the scope of protection of the present invention.

The expression “and/or” used here, when it is used in a series of two or more elements, means that any of the elements listed can be used alone, or any combination of two or more of the elements listed can be used.

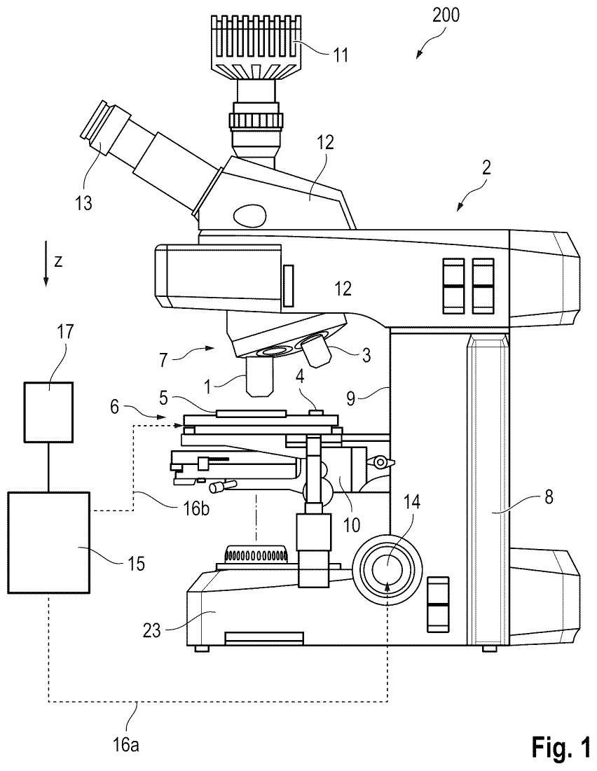

FIG. 1 shows an exemplary embodiment of an arrangement 200 having an image-creating optical system 2 designed as a light microscope. The image-creating optical system 2 comprises an object stage 6, on which a microscope slide is arranged as a carrier substrate 5. The carrier substrate 5 serves to accommodate and position a sample, to be observed, by means of the object stage 6. Moreover, the image-creating optical system 2 comprises an objective changer 7, in which an immersion objective 1 and a reference objective 3, the latter being a dry objective, are inserted. Naturally, further objectives might also be present, for example in the form of dry or immersion objectives. For example, the objective changer 7 can be designed as an objective turret.

Moreover, provision is made for a microscope stand 8 having a base 23 and guides 9, along which the object stage 6 can be moved in the z-direction by means of a focusing drive 10 in order to enable focusing of the objectives 1, 3. The microscope stand 8 moreover supports an eyepiece tube 12, on which eyepieces 13 and a camera 11 are arranged.

In order to displace the focusing drive 10 along the guides 9 for the purpose of focusing the microscope, provision can be made for a motor-driven drive as focusing device 14, the latter being signal-connected to a processing and control unit 15 of the arrangement 200 such that control signals 16a can be transmitted from the processing and control unit 15 to the focusing device 14 in order to bring about focusing. Analogously, the object stage 6 allows positioning of the carrier substrate 5, preferably in motor-driven fashion and by means of control signals 16b from the control unit 15.

The processing and control unit 15 is signal-connected to a memory unit 17 such that values stored in the memory unit 17, e.g. parfocality correction values and/or parcentricity correction values, can be retrieved by the processing and control unit 15, and values generated by the processing and control unit 15 can be stored in the memory unit 17. The specific interaction of the image-creating optical system 2 with the processing and control unit 15 and the memory unit 17 is explained in detail below with reference to the remaining figures.

The production of objectives 1, 3 and installation thereof in the objective changer 7 is linked to tolerances that may lead to deviations in the focality and/or centricity of the objectives 1, 3. Deviations lead to an impaired image quality or to complicated readjustments in the case of a change of objective. As a secondary effect, users spend longer looking for the focus, and, as a result of the small working distances of immersion objectives, this can lead to collisions which may subsequently cause damage to the objective or to microscope modules and significant repair costs connected therewith. To largely prevent this, offset values are used to implement an offset correction for the purpose of compensating the tolerances, the accuracy of said offset correction being greater than the accuracy of the tolerance chain.

In the exemplary embodiment, the offset values are ascertained on the basis of image representations of an object 4 that has a target structure and is stationarily arranged on the object stage 6, as will still be explained in detail below. Alternatively, the object 4 can also be arranged on or integrated in the carrier substrate 5. The target structure of the object 4 is designed such that a focal position can be ascertained when the object 4 is imaged by means of one of the objectives 1, 3.

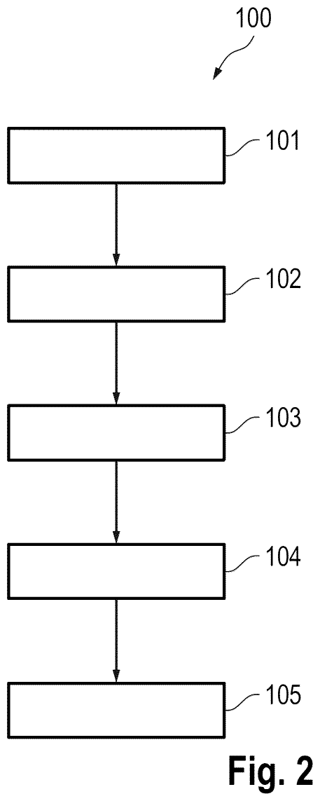

FIG. 2 schematically shows the course of an exemplary method 100 for correcting the offset of an immersion objective 1, for example of the immersion objective 1 in the image-creating optical system 2 from the arrangement shown in FIG. 1.

In step 101, the object 4 or its target structure is imaged both by means of the reference objective and by means of the immersion objective, in each case without immersion.

In the subsequent step 102, base offset values for the offset between the reference objective 3 and the immersion objective 1 without immersion are ascertained from the image representations of the object 4 and on the basis of the image representations of the object 4, these image representations reflecting the offset between the two objectives 1, 3 without immersion. Optionally, a plurality of base offset values can be ascertained, e.g. for a parfocality offset and/or a parcentricity offset.

Offset values for the offset between the reference objective 3 and the immersion objective 1 with immersion are ascertained on the basis of these base offset values in step 103 and stored in step 104.

In the event of a change of objective, for example following a switchover from the reference objective 3 to the immersion objective 1 by means of the objective changer 7, an offset correction is performed in step 105 using the ascertained offset values in order to be able to compensate for an offset of the objectives 1, 3 and obtain image representations of higher quality.

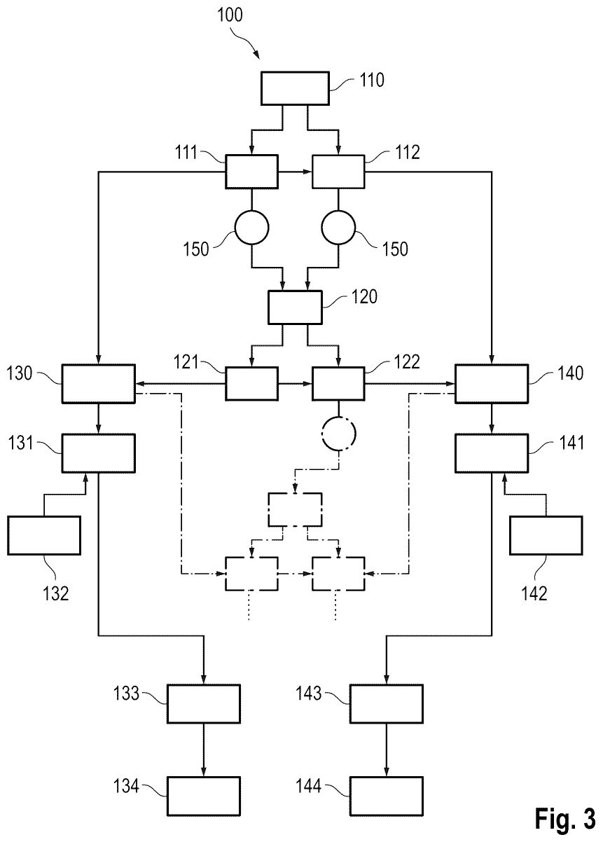

FIG. 3 schematically shows a further exemplary method 100 for correcting offsets. The method 100 according to FIG. 3 provides for both a parfocality correction and a parcentricity correction, as explained in detail below.

The method 100 starts in step 110 with the imaging of an object 4 by means of the reference objective 3 without immersion. In particular, the object 4 can be an object 4 which is stationarily arranged on the microscope and which has a target structure, e.g. a line pattern, on the basis of which automated focusing can be performed. In particular, it is possible to create an image stack in the z-direction. In this context, stationarily can e.g. mean that the target structure is brought to a defined position vis-à-vis the optical system by way of a controllable object stage 6 and z-drive.

The focal position z₁ of the reference objective 3 is ascertained in step 111 on the basis of the image representation of the object 4 or the associated image stack. To this end, a structure feature of the target structure on the object 4 is used, and the contrast thereof and/or the resolution of the images is evaluated. The distance at which a sharp image representation arises can be ascertained from the image representations created for different distances between the reference objective 3 and the target structure in the z-direction, i.e. the image stack in the z-direction. The position of the reference objective 3 accompanying this is the focal position z₁ of the latter. By preference, the focal position z₁ can be determined in automated fashion by means of what is known as an autofocus function. The ascertained focal position z₁ is subsequently used to ascertain the parfocality offset value.

In step 112, the image representation of the object 4 is used to ascertain the object position by means of the reference objective 3 without immersion. To this end, use can be made of the same image representation as for step 111 or of an image representation of the z-image stack. By preference, use can be made of the image representation which corresponds to the focal position z₁ according to step 111. In this case, the use of an image representation that is in focus can lead to a more accurate ascertainment of the object position. In principle, however, the object position can also be ascertained on the basis of a different image representation of the object 4, or use can be made of separate image representations of the object 4 or of a different object 4. Consequently, method steps 111 and 112 can be carried out in any sequence and/or be carried out with a time overlap. The ascertained object position is subsequently used to ascertain the parcentricity offset value.

To avoid changing processes for an automated procedure, it is advantageous to initially ascertain the focal position z1 for the reference objective 3 on the target structure and to position the target structure in the centre of the image field. This is followed by the change to the immersion objective 1, in order to also determine the focal position z2 and the object position there (see the explanations below regarding steps 121 and 122). Further objectives are determined in terms of their focal and position values, without this needing a return to the positioning of the reference objective 3 since the values thereof have already been ascertained.

From step 111 or step 112, the method 100 proceeds with step 120. In step 120, following a change from the reference objective 3 to the immersion objective 1, step 110 is performed analogously, albeit with the immersion objective 1 rather than the reference objective 3, i.e. the object 4 is imaged by means of the immersion objective 1 without immersion, wherein it is once again possible to create an image stack in the z-direction.

Optionally, step 120 can be preceded by a first coarse or approximate offset correction for the immersion objective 3 (intermediate step 150). This approximate offset correction might comprise a parfocality and/or parcentricity correction and for example be carried out on the basis of previously ascertained offset values, e.g. parfocality base offset values, which for example correct the lack of immersion. This can subsequently facilitate the detection of the focal position and/or the object position, and hence automation can be implemented more robustly.

In step 121, the focal position z₂ of the immersion objective 1 is ascertained without immersion, in a manner analogous to the ascertainment of the focal position z₁ of the reference objective 3. By preference, this focal position z₂ can also be determined in automated fashion by means of what is known as an autofocus function.

In step 130, a parfocality base offset value for the parfocality base offset V₁₋₂, which specifies the parfocality offset of the two objectives 1, 3 without immersion, is subsequently ascertained from the ascertained focal positions z₁, z₂ by means of the processing and control unit 15.

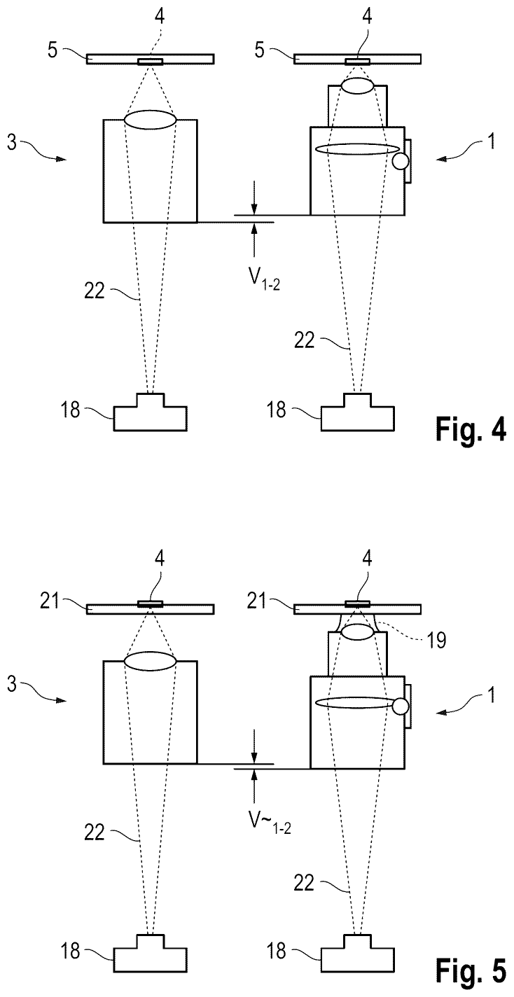

This situation is depicted schematically in FIG. 4. In FIG. 4, the reference objective 3, subsequently also referred to as objective No. 1, is depicted on the left-hand side and the immersion objective 1, subsequently also referred to as objective No. 2, is depicted on the right-hand side. The focal position z₁, z₂ was respectively determined for the two objectives 1, 3 by virtue of an image stack of the object 4 arranged on a microscope slide 5 being recorded in the z-direction by means of an image sensor 18 of an autofocus system and subsequently being evaluated. That is to say, the focal positions z₁, z₂ are ascertained in automated fashion. The position difference of the two objectives 1, 3 in the z-direction, which is required to obtain focused image representations in each case, is the parfocality base offset V₁₋₂ between the reference objective 3, i.e. the objective No. 1, and the immersion objective 1, i.e. the objective No. 2, i.e. the parfocality offset without immersion.

In other words, FIG. 4 shows the parfocality base offset V₁₋₂ between two objectives, specifically the reference objective 3 and the immersion objective 1, the value of which is ascertained from a calibration without immersion. To this end, the focal position z₁, z₂ which achieves the best imaging of the object 4, more precisely of a target structure of the object 4, on the sensor is ascertained for each objective 1, 3. In this case, use is also made of immersion objectives without immersion, in order to simplify handling and avoid manual interactions by the user. The parfocality base offset V₁₋₂=z₂−z₁ specifying the offset that needs to be corrected in order to change from objective No. 1 to objective No. 2 without immersion and in the process image the sample on an image sensor 18 with optimal resolution emerges from the difference of the focal positions z₁, z₂.

Referring back to FIG. 3, step 131 sees an ascertainment of the parfocality offset value for the parfocality offset V˜₁₋₂ between the immersion objective 1 and the reference objective 3 on the basis of the ascertained focal positions z₁, z₂ in the form of the parfocality base offset value and a parfocality correction value c₁₋₂. In intermediate step 132, the parfocality correction value c₁₋₂ is retrieved from the memory unit 17 to this end.

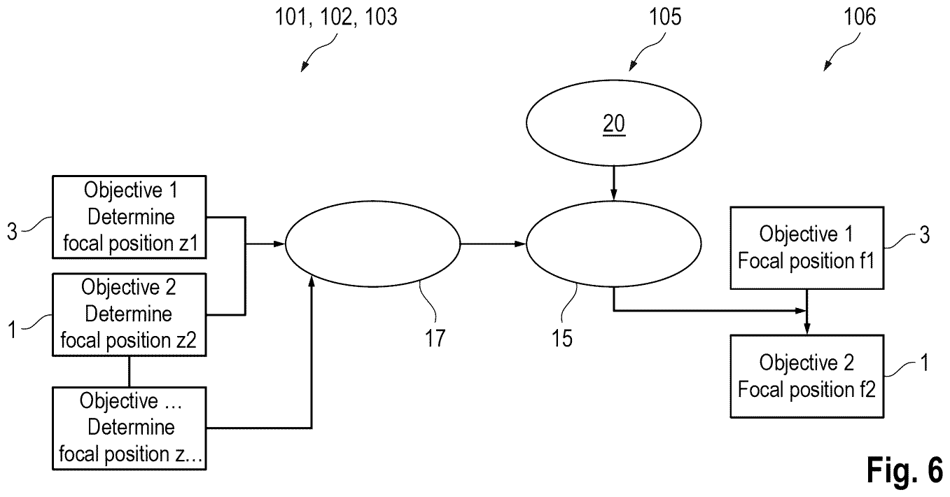

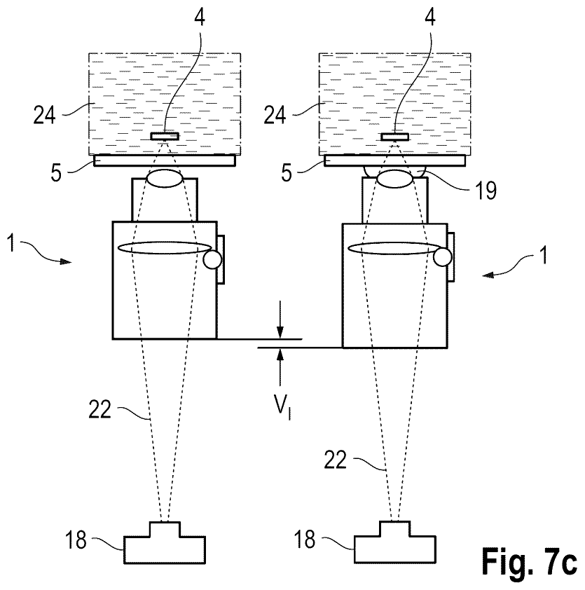

FIG. 5 shows the situation with the parfocality offset V˜₁₋₂ between the immersion objective 1 and the reference objective 3 with immersion, i.e. the immersion objective 3 is used with immersion liquid 19, a water glycerine mixture in the exemplary embodiment. In this case, the object 4 to be imaged is located behind a coverslip 21. With regards to further imaging setups, reference is made to FIGS. 7a to 7c and the explanations thereof.

In other words, FIG. 5 shows the parfocality offset V˜₁₋₂ that has to be taken account when changing between the objectives 1, 3 in order to correct the offset in an observation situation in which the immersion objective 3 is operated with immersion. In the simple approximation shown here, the parfocality correction value c₁₋₂ corresponds to the difference between the parfocality base offset value for the parfocality base offset V₁₋₂ and the parfocality offset value for the parfocality offset V˜₁₋₂, i.e. c₁₋₂=V˜₁₋₂−V₁₋₂ applies.

The parfocality correction value c₁₋₂ can be ascertained experimentally or theoretically, e.g. from an experimental calibration or from an optics simulation. In other words, the parfocality correction value c₁₋₂ can be ascertained experimentally from the measured offset of the focal positions z₁, z₂ for different configurations, e.g. in a manner dependent on a position K of the correction ring, the temperature T or thickness D of the carrier substrate 5 (see also FIG. 4), but also from theoretical optics calculations or by a combination of these approaches.

Referring back to FIG. 3, the parfocality offset value for the parfocality offset V˜₁₋₂ between the immersion objective 1 and the reference objective 3 is stored in step 133, e.g. in the memory unit 17.

The stored parfocality offset value can subsequently be retrieved again and can be used for correcting parfocality when necessary. For example, if there is a change from the reference objective 3 to the immersion objective 1 when the microscope is used and if the immersion objective 3 is used with immersion, then the parfocality offset V˜ᵢ₋ⱼ between the immersion objective 1 and the reference objective 3 is compensated in step 134 by means of the ascertained parfocality offset value.

Steps 110, 111, 120, 121 and 130 to 134 of the method 100 serve to correct parfocality. A parcentricity correction according to steps 110, 112, 120, 122 and 140 to 144 is additionally performed in the exemplary embodiment; however, it is also possible to manage without the parcentricity correction or only carry out a parcentricity correction. Since the parcentricity correction is more accurate when based on focused images, however, ascertaining and setting the focal positions in advance is recommended.

As mentioned previously in step 112, the object position of the object 4 to be imaged is initially ascertained by means of the reference objective 3 without immersion for the purpose of correcting parcentricity. Following the imaging of the object using the immersion objective without immersion in step 120, the object position of the object 4 to be imaged is ascertained by means of the immersion objective 3 in step 122.

In step 140, a parcentricity base offset value which specifies the parcentricity offset of the two objectives 1, 3 without immersion is subsequently ascertained from the ascertained object positions by means of the processing and control unit 15.

In step 141, a parcentricity offset value for the parcentricity offset between the immersion objective 1 and the reference objective 3 is subsequently ascertained on the basis of the parcentricity base offset value. For example, the parcentricity offset value might correspond to the parcentricity base offset value. Optionally, a parcentricity correction value, which can be retrieved from the memory unit 17 in intermediate step 142, can be taken into account when ascertaining the parcentricity offset value.

The parcentricity offset value is stored, e.g. in the memory unit 17, in step 143.

The stored parcentricity offset value can subsequently be retrieved again and can be used for correcting parcentricity when necessary. For example, if there is a change from the reference objective 3 to the immersion objective 1 when the microscope is used and if the immersion objective 3 is used with immersion, then the parcentricity offset between the immersion objective 1 and the reference objective 3 is compensated in step 144 by means of the ascertained parcentricity offset value.

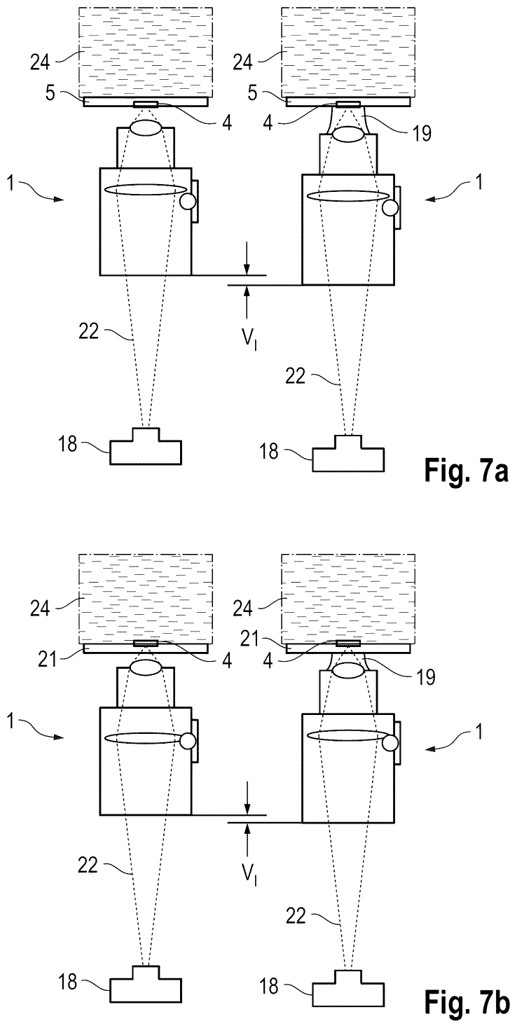

As indicated in the centre of FIG. 3 by the dash-dotted representation, the method 100 can be continued accordingly for further objectives, in particular further immersion objectives. FIG. 6 shows a block diagram for explaining the functionality of the arrangement 200 as per FIG. 1 in accordance with the method 100 according to FIG. 2 or FIG. 3.

As mentioned previously, the arrangement 200 comprises a reference objective 3, denoted objective No. 1 here, which has a focal position z₁ without immersion. Moreover, there is an immersion objective 3, denoted objective No. 2 here, which has a focal position z₂ without immersion. Optionally, further objectives with associated focal positions z might be present, as indicated in FIG. 5. To observe the object 4 to be imaged, it is possible to switch between the reference objective 3, which for example has a low magnification, and the immersion objective 1, which has a higher magnification and also a good resolution on account of the immersion. In this context, an offset correction, in particular a parfocality correction and, optionally, a parcentricity correction as well, is required in order to obtain a good imaging quality without refocusing.

To carry out the parfocality correction of the method 100, the focal positions z₁, z₂ of the reference objective 3 and immersion objective 1 without immersion are ascertained, and from this the parfocality base offset value for the parfocality base offset V₁₋₂ is ascertained. In this case, V₁₋₂=z₂−z₁ applies. Should the parfocality base offset be ascertained for an object position in a chain of objectives, the parfocality base offset simply arises from the addition of the individual base offset values.

V₁₋ᵢ=V₁₋₂+V₂₋₃+ . . . +Vᵢ₋₁₋ᵢ=(z₂−z₁)+(z₃−z₂)+ . . . + (zᵢ−zᵢ₋₁)=zᵢ−z₁. Hence it is clear that the parfocality base offset value between two objectives only includes the ascertained focal positions of the two objectives, and the following applies very generally for a performed measurement series:

$${V}_{i - j} = {z}_{j} - {z}_{i} .$$

The ascertained parfocality base offset value for the parfocality base offset Vᵢ₋ⱼ is stored in the memory unit 17 of the arrangement 200 for a subsequent use.

The parfocality correction value c₁₋₂ is initially ascertained in order to ascertain the parfocality offset value for the parfocality offset V˜₁₋₂, e.g. as per step 131 of the method 100 in FIG. 3. This can be implemented experimentally or on the basis of computations, e.g. on the basis of the optics design underlying the image-creating optical system, and for example be implemented by means of the processing and control unit 15. Within the scope of ascertaining the parfocality correction value c₁₋₂, it is possible to take account of additional influencing factors 20, the influence of which on the parfocality can be ascertained on the basis of additional measurements or computations. The parfocality correction value c₁₋₂ can be stored in the memory unit 17 and can be retrieved therefrom at a later time, for example as per step 133 of the method 100 in FIG. 3. In this context, there can be a parameterization in relation to the structure of the object 4 or changeable optical settings. For example, this relates to performing the calibration for different correction ring settings, but also to taking account of dependencies on the temperature T, the thickness D of the carrier substrate, sample positions vis-à-vis a substrate, or the use of immersion liquids 19 with a variable refractive index, e.g. water glycerine mixtures.

Should objectives have been changed, the processing and control unit 15 ascertains the parfocality offset value for the parfocality offset V˜₁₋₂ on the basis of the parfocality base offset value and the parfocality correction value c₁₋₂. In this case, the following might apply to the focal position f₂ of the immersion objective with immersion: f₂=f₁+V₁₋₂+c₁₋₂, where f₁ is the current focal position of the reference objective 3, which might correspond to the focal position z₁ or else deviate therefrom. If influencing factors 20 are taken into account, the focal position f₂ can in general terms arise as per: f₂=f₁+f(V₁₋₂; c₁₋₂; K; T; D; . . . ).

Expressed differently, the parfocality base offset values for the parfocality base offset Vᵢ₋ⱼ between objectives i, j, which are ascertained for calibrations without immersion, can be stored in the memory unit 17. In the event of a change of objective, the processing and control unit 15 corrects the parfocality base offset Vᵢ₋ⱼ ascertained without immersion in order to obtain, for the imaging situation, the correct parfocality offset value for the parfocality offset V˜ᵢ₋ⱼ. The correction is dominated by the imaging effect of the immersion in particular, wherein however further influencing factors 20 can optionally be taken into account.

To compensate the parfocality offset V˜₁₋₂, e.g. as per step 134 of the method 100 in FIG. 3, the processing and control unit 15 creates a corresponding control signal 16, which is output to the focusing device 14 in order to bring about a change in the distance in the z-direction between the object 4 and the immersion objective 1.

As mentioned, a parcentricity correction can be implemented analogously.

The proposed technical solution enables a workflow which performs the parfocality correction in completely automated fashion and, in particular, even without the required immersion liquid in the case of immersion objectives.

Different imaging setups for the immersion objective 3 are depicted in FIGS. 7a to 7c. In this case, the left-hand side of the figures in each case shows the situation without immersion, and the right-hand side shows the situation with immersion. Moreover, the respective immersion-related parfocality offset V_{I} is plotted, the latter arising between the operation of the immersion objective 1 without immersion and with immersion and being taken in to account in the proposed method by means of the parfocality correction value cᵢ₋ⱼ.

In FIG. 7a, the object 4 to be imaged is arranged on a microscope slide 5 and in direct contact with the immersion liquid 19 in the event of immersion. Moreover, an embedding medium 24 is arranged on the side of the carrier substrate 5 distant from the image sensor 18.

In FIG. 7b, the object 4 to be imaged is arranged behind a first substrate, e.g. a coverslip 21. In this case, the immersion liquid 19 is located between the coverslip 21 and the immersion objective 1.

In FIG. 7c, the object 4 to be imaged is arranged at a distance behind a microscope slide 5. In this case, the immersion liquid 19 is located between the microscope slide 5 and the immersion objective 1.

Since the light beams 22 travel paths of different length in the immersion liquid and different media transitions emerge in the various imaging setups, immersion-related parfocality offsets V_{I} that slightly differ from one another arise. Consequently, the ascertainment and use of a separate parfocality correction value cᵢ₋ⱼ for each imaging setup is recommended in order to obtain a parfocality correction that is as accurate as possible. An analogue procedure can be implemented for the parcentricity correction.

### LIST OF REFERENCE SIGNS

1 Immersion objective
2 Image-creating optical system
3 Reference objective
4 Object
5 Carrier substrate
6 Object stage
7 Objective changer
8 Microscope stand
9 Guide
10 Focusing drive
11 Camera
12 Eyepiece tube
13 Eyepiece
14 Focusing device
15 Processing and control unit
16a, 16b Control signal
17 Memory unit
18 Image sensor
19 Immersion liquid
20 Influencing factor
21 Coverslip
22 Light beam
23 Base
24 Embedding medium
100 Method
101 Imaging an object using the reference objective and the immersion objective without immersion
102 Ascertaining base offset values for the offset between the reference objective and the immersion objective on the basis of the image representations of the object
103 Ascertaining offset values for an offset between the reference objective and the immersion objective
104 Storing the offset values
105 Performing an offset correction using the ascertained offset values
110 Imaging an object using the reference objective without immersion
111 Ascertaining the focal position of the reference objective without immersion
112 Ascertaining the object position of an object by means of the reference objective without immersion
120 Imaging the object using the immersion objective without immersion
121 Ascertaining the focal position of the immersion objective without immersion
122 Ascertaining the object position of the object, to be imaged, by means of the reference objective without immersion
130 Ascertaining a parfocality base offset value for the parfocality offset between the immersion objective and the reference objective from the ascertained focal positions without immersion
131 Ascertaining a parfocality offset value for the parfocality offset between the immersion objective and the reference objective on the basis of the parfocality base offset value and a parfocality correction value
132 Retrieving a parfocality correction value
133 Storing the parfocality offset value
134 Compensating the parfocality offset between the immersion objective and the reference objective
140 Ascertaining a parcentricity base offset value for the parcentricity offset between the immersion objective and the reference objective from the ascertained object positions without immersion
141 Ascertaining a parcentricity offset value for the parcentricity offset between the immersion objective and the reference objective on the basis of the parcentricity base offset value
142 Retrieving a parcentricity correction value
143 Storing the parcentricity offset value
144 Compensating the parcentricity offset between the immersion objective and the reference objective
150 Performing an approximate offset correction
200 Arrangement
cᵢ₋ⱼ Parfocality correction value for correcting the parfocality base offset between the objectives i and j
d Parcentricity correction value for correcting the parcentricity base offset
f₁ Focal position of the reference objective
f₂ Focal position of the immersion objective (with immersion)
D Thickness of the microscope slide
K Position of the correction ring
T Temperature
Vᵢ₋ⱼ Parfocality base offset between objectives i and j
V˜ᵢ₋ⱼ Parfocality offset between objectives i and j
V_{I} Immersion-related parfocality offset
z₁ Focal position of the reference objective without immersion
z₂ Focal position of the immersion objective without immersion

What is claimed is:

1. A method (100) for ascertaining offset values for correcting an offset of an immersion objective (1) of an image-creating optical system (2), the method (100) comprising:
imaging an object (4) using a reference objective (3) of the image-creating optical system (2) and the immersion objective (1) without immersion (101, 110, 120); and
ascertaining offset values for an offset between the reference objective (3) and the immersion objective (1) with immersion based on image representations of the object (4) (103, 131, 141).

2. The method (100) according to claim 1, further comprising:
ascertaining base offset values for the offset between the reference objective (3) and the immersion objective (1) based on the image representations of the object (4) (102, 130, 140),
wherein the offset values are ascertained based on the base offset values.

3. The method (100) according to claim 1,
wherein offset values are ascertained for correcting parfocality and/or correcting parcentricity.

4. The method (100) according to claim 3,
wherein the ascertainment of offset values for correcting parfocality comprises
ascertaining a focal position (z₁) of the reference objective (3) of the image-creating optical system (2) without immersion (111),
ascertaining a focal position (z₂) of the immersion objective (1) without immersion (121), and
ascertaining a parfocality offset value for a parfocality offset (V˜₁₋₂) between the immersion objective (1) and the reference objective (3) based on the ascertained focal positions (z₁, z₂) and at least one parfocality correction value (c₁₋₂) (131).

5. The method (100) according to claim 4, including:
ascertaining a parfocality base offset value for the parfocality base offset (V₁₋₂) between the immersion objective (1) and the reference objective (3) from the ascertained focal positions (z₁, z₂) without immersion (130),
wherein the parfocality offset value is ascertained based on the parfocality base offset value and the parfocality correction value (c₁₋₂).

6. The method (100) according to claim 4, including:
experimentally ascertaining the parfocality correction value (c₁₋₂) using the immersion objective (1) with immersion.

7. The method (100) according to claim 4, including:
computationally ascertaining the parfocality correction value (c₁₋₂).

8. The method (100) according to claim 7, including:
correcting the parfocality offset (V˜₁₋₂) compensated by the computationally ascertained parfocality correction value (c₁₋₂),
ascertaining a corrected parfocality correction value based on the compensated parfocality offset (V˜₁₋₂), and
storing the corrected parfocality correction value.

9. The method (100) according to claim 4,
wherein the parfocality correction value (c₁₋₂) takes account of an influencing factor (20) selected from the group consisting of a composition of an immersion liquid, a temperature (T) of the immersion liquid, a wavelength of an electromagnetic radiation used for imaging with the image-creating optical system (2), a thickness (D) of a carrier substrate (5), a refractive index of the carrier substrate (5), a distance of the object (4) from the carrier substrate (5), a setting of a correction element of the immersion objective (1), and a position of the object (4) with respect to the carrier substrate (5).

10. The method (100) according to claim 3,
wherein the ascertainment of offset values for correcting parcentricity comprises:
ascertaining an object position of an object (4) by means of the reference objective (3) without immersion (112),
ascertaining the object position of the object (4) by means of the immersion objective (1) without immersion (122), and
ascertaining a parcentricity offset value for a parcentricity offset between the immersion objective (1) and the reference objective (3) based on the ascertained object positions without immersion (141).

11. The method (100) according to claim 10,
wherein the parcentricity offset value is ascertained based on the ascertained object positions without immersion and at least one parcentricity correction value (d).

12. The method (100) according to claim 11, including:
experimentally ascertaining the parcentricity correction value (d) using the immersion objective (1) with immersion.

13. The method (100) according to claim 11, including:
computationally ascertaining the parcentricity correction value (d).

14. The method (100) according to claim 13, including:
correcting the parcentricity offset compensated by the computationally ascertained parcentricity correction value (d),
ascertaining a corrected parcentricity correction value based on the compensated parcentricity offset, and
storing the corrected parcentricity correction value.

15. The method (100) according to claim 11,
wherein the parcentricity correction value (d) takes account of an influencing factor (20) selected from the group consisting of a composition of an immersion liquid, a temperature (T) of the immersion liquid, a wavelength of an electromagnetic radiation used for imaging with the image-creating optical system (2), a thickness (D) of a carrier substrate (5), a refractive index of the carrier substrate (5), a distance of the object (4) from the carrier substrate (5), a setting of a correction element of the immersion objective (1), and a position of the object (4) with respect to the carrier substrate (5).

16. The method (100) according to claim 4,
wherein the focal positions (z₁, z₂) are ascertained in automated fashion.

17. The method (100) according to claim 1,
wherein the object (4) is an object arranged permanently on the image-creating optical system (2) or arranged stationarily on a carrier substrate (5).

18. The method (100) according to claim 1, wherein the image-creating optical system (2) is a light microscope.

19. An arrangement (200), comprising:
an image-creating optical system (2) having an immersion objective (1) and a reference objective (3), and
means adapted such that they carry out the method (100) according to claim 1.

20. The arrangement (200) according to claim 18,
wherein the image-creating optical system (2) is a light microscope.

21. A non-transitory computer-readable medium comprising commands that cause an image-creating optical system (2) having an immersion objective (1) and a reference objective (3) to carry out a method (100), comprising:
imaging an object (4) using the reference objective (3) of the image-creating optical system (2) and the immersion objective (1) without immersion (101, 110, 120); and
ascertaining offset values for an offset between the reference objective (3) and the immersion objective (1) with immersion based on image representations of the object (4) (103, 131, 141).
